(19) United States
(12) Patent Application Publication
(10) Pub. No.: US 2021/0112093 A1
(43) Pub. Date: Apr. 15, 2021

(54) MEASURING ADDRESS RESOLUTION PROTOCOL SPOOFING SUCCESS

(71) Applicant: Avast Software s.r.o., Prague (CZ)

(72) Inventor: Hana Dusíková, Zd'ar nad Sazavou (CZ)

(21) Appl. No.: 16/601,341

(22) Filed: Oct. 14, 2019

(51) Int. Cl. H04L 29/06; H04L 29/12

(52) U.S. Cl. CPC H04L 63/1466; H04L 63/1483; H04L 63/145; H04L 61/103

(57) ABSTRACT

ARP spoofing success for a network security device is measured by inserting the network security device between a router or gateway and one or more private network clients by using ARP spoofing, and sending a ping from the private network device to the private network clients using the IP address of the router or gateway. Private network clients are identified as successfully ARP spoofed if a ping response is received. If a ping response is not received from one or more clients, a ping is sent from the security device to the missing client using the security device's own source IP address. If a response to the ping is received it is determined that the ARP spoofing was unsuccessful, and if response to the ping is not received it is determined that the client device is not present in the private network.

### FIELD

The invention relates generally to computer network addressing, and more specifically to measuring Address Resolution Protocol (ARP) spoofing success.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

But, because the size of the Internet is so large and Internet users are so diverse in their interests, it is not uncommon for malicious users to attempt to communicate with other users' computers in a manner that poses a danger to the other users. For example, a hacker may attempt to log in to a corporate computer to steal, delete, or change information. Computer viruses or Trojan horse programs may be distributed to other computers or unknowingly downloaded such as through email, download links, or smartphone apps. Further, computer users within an organization such as a corporation may on occasion attempt to perform unauthorized network communications, such as running file sharing programs or transmitting corporate secrets from within the corporation's network to the Internet.

For these and other reasons, many computer systems employ a variety of safeguards designed to protect computer systems against certain threats. Firewalls are designed to restrict the types of communication that can occur over a network, antivirus programs are designed to prevent malicious code from being loaded or executed on a computer system, and malware detection programs are designed to detect remailers, keystroke loggers, and other software that is designed to perform undesired operations such as stealing information from a computer or using the computer for unintended purposes. Similarly, web site scanning tools are used to verify the security and integrity of a website, and to identify and fix potential vulnerabilities.

For example, a firewall in a home or office may restrict the types of connection and the data that can be transferred between the internal network and an external or public network such as the Internet, based on firewall rules and characteristics of known malicious data. The firewall is typically a computerized network device that inspects network traffic that passes through it, permitting passage of desirable network traffic while blocking undesired network traffic based on a set of rules. A firewall or similar network security device may be integrated into a home or small business router, or may be a standalone device such as a device connected to a router and configured to filter traffic coming into a private network from a public network before forwarding it to devices on the private network.

In a more detailed example of a standalone security device not integrated within a router, the network security device is coupled to the router via a network connection and is configured to receive or intercept data sent between external computer systems and devices on the internal private network. This is achieved in one example by using Address Resolution Protocol (ARP) spoofing, by which the security device associates its own MAC address with the IP address of a different device that is a target of communication. The security device can then intercept the network data and screen it before forwarding it to the intended destination, such as an internal private network device. In other examples, other methods are similarly used to configure the security device between the external network and internal or private network devices.

But, such solutions can be difficult to implement, as the network protocols are being used in a way that is not intended to perform ARP spoofing. Further, ARP spoofing may not properly update all clients on the network, leaving some devices unprotected. It is therefore desirable to manage application of ARP spoofing as a security solution to provide greater security to devices on a protected network.

### SUMMARY

In one example embodiment, ARP spoofing success for a network security device is measured by inserting the network security device between a router or gateway and one or more private network clients by using ARP spoofing, and sending a ping from the private network device to the private network clients using the IP address of the router or gateway. Private network clients are identified as successfully ARP spoofed if a ping response is received.

In a another example, if a ping response is not received from one or more clients, a second ping is sent from the security device to the missing client using the security device's own source IP address. If a response to the second ping is received it is determined that the ARP spoofing was unsuccessful, and if response to the second ping is not received it is determined that the client device is not present in the private network.

In a further example, evaluation of ARP spoofing success is repeated periodically to provide ongoing protection to the one or more private network clients by ensuring that the private network client devices continue to communicate with a public network via the security device.

In another example, if ARP spoofing is unsuccessful for a client device, the frequency of ARP packets sent as part of using Address Resolution Protocol (ARP) spoofing is increased.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a private network with a network security device configured to perform and measure ARP spoofing, consistent with an example embodiment.

FIG. 2 is a flowchart of a method of measuring ARP spoofing success in a network, consistent with an example embodiment.

FIG. 3 is a computerized network security device, consistent with an example embodiment of the invention

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As networked computers and computerized devices such as smart phones become more ingrained into our daily lives, the value of the information they store, the data such as passwords and financial accounts they capture, and even their computing power becomes a tempting target for criminals. Hackers regularly attempt to log in to computers to steal, delete, or change information, or to encrypt the information and hold it for ransom via “ransomware.” Smartphone apps, Microsoft® Word documents containing macros, Java™ applets, and other such common documents are all frequently infected with malware of various types, and so users rely on tools such as antivirus software or other malware protection tools to protect their computerized devices from harm.

An increasing number of computerized devices such as home appliances, vehicles, and other devices (known collectively as the Internet of Things, or IoT) are connected to public networks and are also susceptible to unauthorized interception or modification of data. For example, many popular security cameras are known to have vulnerabilities through which attackers can access the device without authorization, enabling the attackers to view and record image data from the cameras or to control camera operation. Similar vulnerabilities are known to exist or may exist in other IoT devices, including network-connected home security systems such as electronic locks, home appliances such as smart thermostats or kitchen appliances, and vehicles with network access. The Internet of Things, and associated potential security risks, extend to a wide variety of other environments and applications including commercial applications such as manufacturing monitoring and control systems, medical and health care devices used to diagnose or treat medical conditions, and infrastructure monitoring and control such as bridges, railways, wind farms, and the like.

In a typical home computer or corporate environment, firewalls inspect and restrict the types of communication that can occur between local devices such as computers or IoT devices and the Internet, antivirus programs prevent known malicious code from being loaded or executed on a computer system, and malware detection programs detect known malicious code such as remailers, keystroke loggers, and other software that is designed to perform undesired operations such as stealing information from a computer or using the computer for unintended purposes.

A firewall or similar network security device in a home or office may be integrated into a router, or may be a standalone device such as a device connected to a router and configured to filter traffic coming into a private network from a public network before forwarding it to devices on the private network. In a more detailed example of a standalone security device, the device is coupled to a router via a network connection and is configured to receive or intercept data sent between external computer systems and devices on the internal private network, such as by Address Resolution Protocol (ARP) spoofing, Dynamic Host Configuration Protocol (DHCP) settings, or another suitable method.

In ARP spoofing, the security device associates its own MAC addresses with the IP addresses of the network's router and at least one device on the private network to be protected by the security device, such that a substitute MAC address of the network security device is associated with the protected device's IP address rather than the protected device's own MAC address. The security device achieves this in a more detailed example by sending ARP packets across the internal network that contain the security device's MAC address and the protected device's IP address, such that other devices on the network such as the router and switches will cache the MAC address of the security device as being associated with the protected device's IP address. Network data on the internal network destined for the protected device will therefore instead be routed to the security device, which can screen it before forwarding it to the protected device on the private network. This process is repeated for other devices to be protected.

In a further example, a similar process is also performed for the router such that the outbound traffic from local network devices destined for the router is also filtered by the security device. In one such example, network traffic from private network devices destined for the router's IP address are routed to the security device via a spoofed MAC address associated with the router's IP address, distributed by ARP request packets as described above.

But, such systems rely upon using the Address Resolution Protocol (ARP) in a way it was not designed to be used, and some devices may not respond to the ARP spoofing process as hoped. For example, if a client device is actively communicating with the router while ARP spoofing is attempted, a data stream between the router and client device may interfere with successful ARP spoofing. In other examples, cached or hard-coded MAC address data may not be updated by the ARP spoofing attempt, and the device may remain unattached to the security device. In a further example, a device that infrequently connects to the private network or that is new to the network may miss the ARP spoofing attempt, and so communicate directly with the router or gateway device.

Some example embodiments described herein therefore seek to measure the success of ARP spoofing in a network, and in further examples to perform one or more functions if ARP spoofing for one or more devices was unsuccessful. In a more detailed example, ARP spoofing success for a network security device is measured by inserting the network security device between a router or gateway and one or more private network clients by using ARP spoofing, and sending a ping from the private network device to the private network clients using the IP address of the router or gateway. Private network clients are identified as successfully ARP spoofed if a ping response is received. In a further example, if a ping response is not received from one or more clients, a second ping is sent from the security device to the missing client using the security device's own source IP address. If a response to the second ping is received it is determined that the ARP spoofing was unsuccessful, and if response to the second ping is not received it is determined that the client device is not present in the private network.

In a further example, ongoing network security is provided by periodically evaluating ARP spoofing success, ensuring that the private network client devices continue to communicate with a public network via the security device. In another example, if ARP spoofing is unsuccessful for a client device, the frequency of ARP packets sent as part of using Address Resolution Protocol (ARP) spoofing is increased to improve the chances of ARP spoofing success.

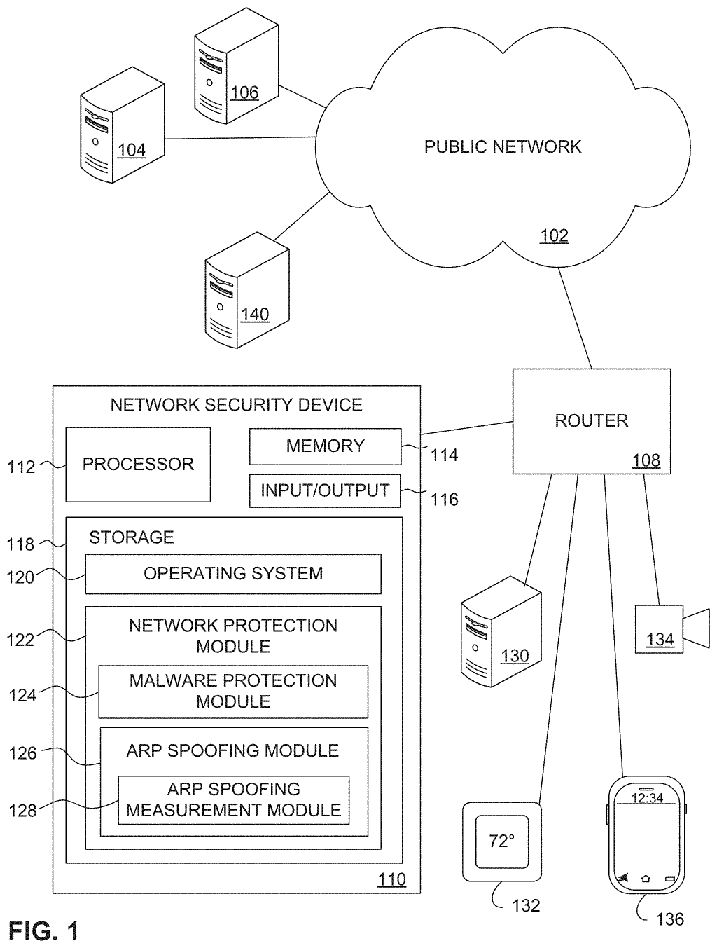

FIG. 1 shows a private network with a network security device configured to perform and measure ARP spoofing, consistent with an example embodiment. Here a public network 102 links remote computer systems such as servers 104 and 106 to a private local network via router 108. The private network in this example includes network security device 110, which includes a processor 112, memory 114, input/output 116 (such as a network interface), and storage 118. The storage stores instructions executable on processor 112 to perform certain functions, including operating system 120 and network protection module 122.

The network protection module includes a malware protection module 124 which is operable to inspect traffic between one or more private network devices and the public network 102 for malicious content, as well as ARP spoofing module 126 operable to spoof the IP addresses of the router or gateway and the client devices to insert itself between the devices on the network. The ARP spoofing module 126 includes ARP spoofing measurement module 128, which is operable to use functions such as ICMP pings to determine whether ARP spoofing is successful for each of the client devices on the private network.

The private network also includes one or more client devices, such as computer 130, smart thermostat 132, camera 134, and smartphone 136. The network security device in this example is configured to protect the private network devices from threats such as attacker 140, or other such threats coming from the public network 102 to the private network via the router or gateway 108.

In operation, the various devices on the private network, such as computer 130, smart thermostat 132, camera 134, and smartphone 136, are configured to exchange data with one or more computerized devices on the public network, such as servers 104 and 106. For example, computer 130 and smartphone 136 may load web pages and emails from public network servers, while smart thermostat 132 and camera 134 send data regarding their operation to servers configured to facilitate control and storage of HVAC and captured video data.

Because each of these private network devices is operable to exchange data with other computerized devices, including those on the public network, they are vulnerable to the data being intercepted and tampered with or to being attacked with various types of malicious software or malware. For example, attacker 140 may target computer 130 with viruses that infect the computer and perform functions such as mine cryptocurrency, send spam emails, encrypt files that are held ransom for payment (ransomware), or other such malicious activity. Smart thermostat 132 may have its heating and cooling setting tampered with, or may have other features such as an interactive voice service such as Alexa tampered with to enable eavesdropping or other malicious activity. Similarly, camera 134 may be hacked such that attacker 140 or another remote user on the public network 102 can monitor activity visible to the camera or use other functions such as a speaker to interact with people local to the camera.

The private network devices 130-136 communicate with devices on the public network 102 via router 108, which directs traffic from the private network devices 130-136 to the public network and from the public network to the intended private network devices. In the example of FIG. 1, the network security device 110 will employ its ARP spoofing module 126 to “spoof” or take the place of the router to the private network client devices 130-136, and will selectively “spoof” or take the place of one or more of the private network devices 130-136 to the router 108 and devices on the public network 102. The malware protection module 124 is then operable to screen or filter network traffic between the private network devices 130-136 and the public network, such as to block known or suspected malware or other security threats in network traffic from the public network to the private network devices.

In a more detailed example of ARP spoofing, the network security device 110 provides protection private network devices 130-136 by taking advantage of network protocols for establishing network address records to insert itself between communicating network devices. A new device attached to a private network is typically assigned an IP address using the Dynamic Host Configuration Protocol, or DHCP, via a DHCP server (such as router 108) that is responsible for ensuring each device on the private network has a unique IP address. The new device broadcasts a DHCP discovery request on the private network, and one or more DHCP servers receive the request and reserve an IP address which is then offered to the new device. The new device replies with a DHCP request accepting the reserved IP address from a DHCP server (accepting only a single offer if multiple IP address offers are received), which the DHCP server then acknowledges. The new device then sends an Address Resolution Protocol (ARP) request across the network, ensuring it is the only device on the private network using the assigned IP address.

When the new device wishes to communicate with another device on the network, it broadcasts an ARP request packet with the intended destination's IP address. The intended destination computer responds with its MAC address, which the new device and any other listening devices then store in an ARP table associated with the intended destination's IP address for future use. The new device can now use the intended destination's MAC address to communicate with the intended destination device.

The network security device 110 of FIG. 1 in some examples uses ARP spoofing to selectively “spoof” or take the place of the router to one or more of the local network devices 130-136, and to selectively “spoof” or take the place of one or more of the local network devices 130-136 to the router 108. In both cases, the network security device forwards data received as a result of such “spoofing” to the intended destination after screening the data, enabling the network security device 110 to monitor and restrict communication between local devices 130-136 and the router (including traffic between local devices 130-136 and the public network via the router). ARP spoofing is achieved in a more detailed example by sending an ARP announcement broadcast to other devices on the private network that falsely updates IP to MAC address mapping in private network devices so that data intended for select devices instead is routed to the network security device's MAC address, enabling network security device to insert itself as “man-in-the-middle” between select private network devices 130-136 and the router.

In the example of FIG. 1, some client devices 130-136 may not successfully respond to the network security device 110's ARP spoofing attempt, and so may remain directly connected to the router 108. This can happen for a variety of reasons, such as multiple or conflicting MAC addresses being cached for the same IP in a client device, or devices that may connect to the private network only intermittently such as video camera 134 being in an inactive state or smart phone 136 being away from home when an ARP spoofing attempt takes place. The ARP spoofing measurement module 128 is therefore employed to measure the success of ARP spoofing in the private network, and in further examples to take actions such as increasing the ping rate or notify a user if ARP spoofing is unsuccessful for one or more private network devices.

In a more detailed example, the ARP spoofing measurement module determines the success of ARP spoofing by sending a ping to one or more of the private network clients using the IP address of the router or gateway, and determining that ARP spoofing was successful for clients that respond to the ping. In a further example, for clients that do not respond, the ARP spoofing measurement module sends another ping using its own source IP address, such that if a response is received when pinging with its own IP address but not when using the router's spoofed IP address, ARP spoofing is determined to be unsuccessful. If no response to the ping using the security device's own IP address is received, it is determined that the pinged device is no longer attached to the network, and it is therefore not considered a failed ARP spoofing attempt.

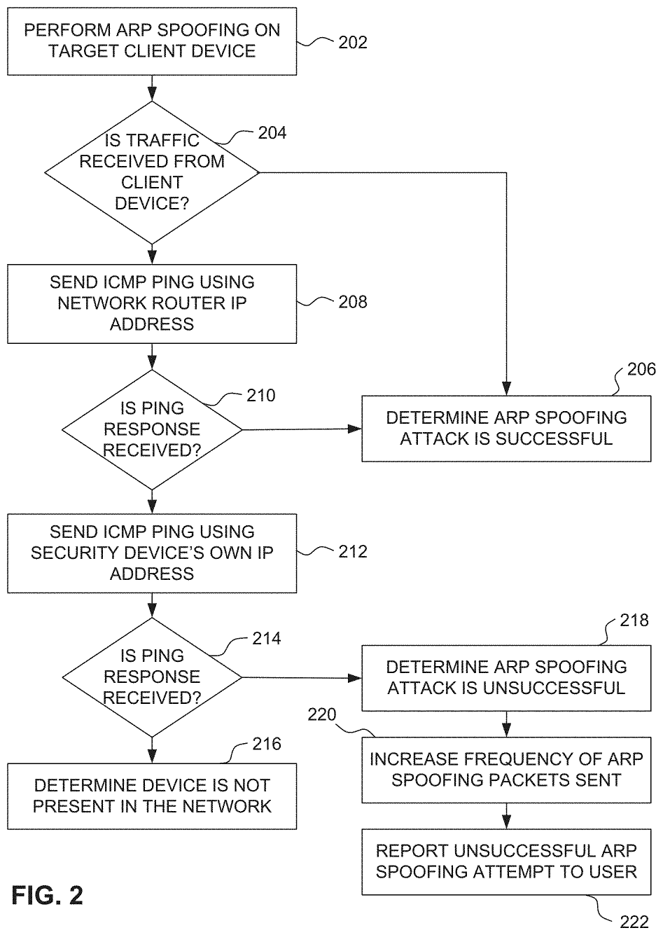

FIG. 2 is a flowchart of a method of measuring ARP spoofing success in a network, consistent with an example embodiment. At 202, the network security device attempts to insert itself between a router or gateway and one or more client devices on the private network by performing ARP spoofing. As previously discussed, this involves sending false ARP request packets identifying the security device's MAC address as being associated with the router's IP address. If ARP spoofing is successful, traffic sent between client devices and the router will instead be sent to the security device, which can then inspect the traffic for malware or other threats before selectively forwarding the traffic to the intended recipient. If the security device receives traffic from a client device at 204, it can therefore determine that ARP spoofing was successful as shown at 206.

If the security device does not receive traffic from a client device, it takes further steps to determine whether ARP spoofing was successful or unsuccessful for the device, or whether the device is missing from the network. At 208, the security device sends an ICMP ping to the client device using the network router's IP address, in effect pretending to be the network router. If the security device receives a ping response from the client device at 210, it knows that traffic destined for the router's IP address is being sent to it and can again determine that ARP spoofing was successful for the device at 206.

If a ping response is not received at 210, the security device sends another ICMP ping to the client device, but using its own IP address instead of the router's IP address. If a response to the ping is not received from the client device at 214, the security device can determine that the client device is not present in the network at 216. If the security device does receive a response to a ping request using the security device's own IP address at 212-214, but does not receive a response when using the router's IP address at 208-210, the security device determines at 218 that the ARP spoofing attack on the client was unsuccessful. In further examples, the security device then takes further actions, such as to increase the frequency of ARP spoofing packets sent at 220 to increase the chances of ARP spoofing success, and/or to report the unsuccessful ARP spoofing determination to a user at 222 so that the user knows one or more devices may not be protected by the security device.

The various methods described herein therefore provide the benefit of being able to distinguish between devices that have been successfully ARP spoofed but have simply not sent traffic to the security device, and devices that have not been successfully ARP spoofed. It also distinguishes between devices that are not present on the network, and devices that are present bur for which ARP spoofing was unsuccessful. Although the examples presented above typically involve a security device such as a virus or malware scanner, an Intrusion Detection System (IDS), or an Intrusion Prevention system (IPS), in other examples functions such as those described in the examples above will be performed by other devices or modules than those shown in FIG. 1, such as ARP spoofing to implement redundancy or load balancing in a network. One example of the network security device as shown in FIG. 1 is described in greater detail below.

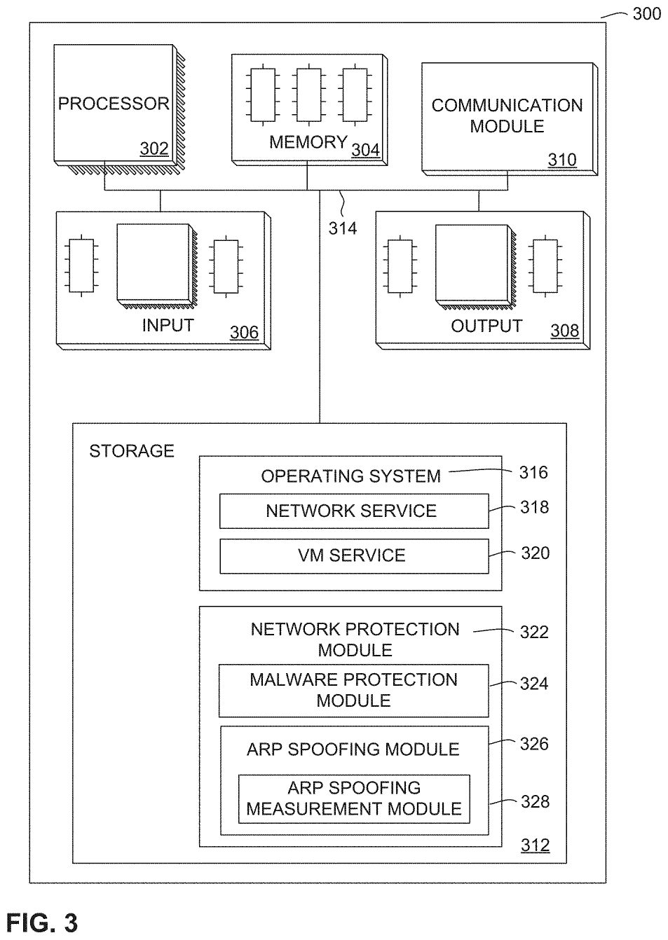

FIG. 3 is a computerized network security device, consistent with an example embodiment of the invention. FIG. 3 illustrates only one particular example of network security device 300, and other computing devices may be used in other embodiments. Although network security device 300 is shown as a standalone computing device, device 300 may be any component or system that includes one or more processors or another suitable computing environment for executing software instructions in other examples, and need not include all of the elements shown here.

As shown in the specific example of FIG. 3, network security device 300 includes one or more processors 302, memory 304, one or more input devices 306, one or more output devices 308, one or more communication modules 310, and one or more storage devices 312. Device 300 in one example further includes an operating system 316 executable by network security device 300. The operating system includes in various examples services such as a network service 318 and a virtual machine service 320 such as a virtual server or various modules described herein. One or more applications, such as network protection module 322 are also stored on storage device 312, and are executable by network security device 300.

Each of components 302, 304, 306, 308, 310, and 312 may be interconnected (physically, communicatively, and/or operatively) for inter-component communications, such as via one or more communications channels 314. In some examples, communication channels 314 include a system bus, network connection, inter-processor communication network, or any other channel for communicating data. Applications such as network security module 322 and operating system 316 may also communicate information with one another as well as with other components in device 300.

Processors 302, in one example, are configured to implement functionality and/or process instructions for execution within computing device 300. For example, processors 302 may be capable of processing instructions stored in storage device 312 or memory 304. Examples of processors 302 include any one or more of a microprocessor, a controller, a digital signal processor (DSP), an application specific integrated circuit (ASIC), a field-programmable gate array (FPGA), or similar discrete or integrated logic circuitry.

One or more storage devices 312 may be configured to store information within network security device 300 during operation. Storage device 312, in some examples, is known as a computer-readable storage medium. In some examples, storage device 312 comprises temporary memory, meaning that a primary purpose of storage device 312 is not long-term storage. Storage device 312 in some examples is a volatile memory, meaning that storage device 312 does not maintain stored contents when network security device 300 is turned off. In other examples, data is loaded from storage device 312 into memory 304 during operation. Examples of volatile memories include random access memories (RAM), dynamic random access memories (DRAM), static random access memories (SRAM), and other forms of volatile memories known in the art. In some examples, storage device 312 is used to store program instructions for execution by processors 302. Storage device 312 and memory 304, in various examples, are used by software or applications running on network security device 300 such as network protection module 322 to temporarily store information during program execution.

Storage device 312, in some examples, includes one or more computer-readable storage media that may be configured to store larger amounts of information than volatile memory. Storage device 312 may further be configured for long-term storage of information. In some examples, storage devices 312 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Network security device 300, in some examples, also includes one or more communication modules 310. Computing device 300 in one example uses communication module 310 to communicate with external devices via one or more networks, such as one or more wireless networks. Communication module 310 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, network security device 300 uses communication module 310 to communicate with an external device such as via public network 122 of FIG. 1.

Network security device 300 also includes in one example one or more input devices 306. Input device 306, in some examples, is configured to receive input from a user through tactile, audio, or video input. Examples of input device 306 include a touchscreen display, a mouse, a keyboard, a voice-responsive system, a video camera, a microphone, or any other type of device for detecting input from a user.

One or more output devices 308 may also be included in computing device 300. Output device 308, in some examples, is configured to provide output to a user using tactile, audio, or video stimuli. Output device 308, in one example, includes a display, a sound card, a video graphics adapter card, or any other type of device for converting a signal into an appropriate form understandable to humans or machines. Additional examples of output device 308 include a speaker, a light-emitting diode (LED) display, a liquid crystal display (LCD), or any other type of device that can generate output to a user.

Network security device 300 may include operating system 316. Operating system 316, in some examples, controls the operation of components of network security device 300, and provides an interface from various applications such as network protection module 322 to components of network security device 300. For example, operating system 316, in one example, facilitates the communication of various applications such as network protection module 322 with processors 302, communication unit 310, storage device 312, input device 306, and output device 308. Applications such as network protection module 322 may include program instructions and/or data that are executable by computing device 300. As one example, network protection module 322 provides protection from malware and other threats using malware protection module 324, and performs ARP spoofing to insert itself between protected client devices and a router or gateway via ARP spoofing module 326. The success of ARP spoofing is determined by ARP spoofing measurement module 328. These and other program instructions or modules may include instructions that cause network security device 300 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of measuring Address Resolution Protocol (ARP) spoofing success for a private network device, comprising:
inserting the private network device between a router or gateway and one or more private network clients by using Address Resolution Protocol (ARP) spoofing;
sending a ping from the private network device to one or more of the private network clients using the IP address of the router or gateway; and
identifying the one or more private network clients as successfully ARP spoofed if a ping response is received.

2. The method of measuring Address Resolution Protocol (ARP) spoofing success of claim 1, further comprising determining whether one or more private network clients is missing from the private network or was unsuccessfully ARP spoofed by pinging the private network clients from the private network device using the private network device's own IP address.

3. The method of measuring Address Resolution Protocol (ARP) spoofing success of claim 2, wherein if a response to a ping from the private network device using the private network device's own source IP address to a private network client device is received it is determined that the ARP spoofing was unsuccessful, and if response to the ping is received it is determined that the client device is not present in the private network.

4. The method of measuring Address Resolution Protocol (ARP) spoofing success of claim 2, wherein the method is repeated periodically to provide updated measurement of ARP spoofing success.

5. The method of measuring Address Resolution Protocol (ARP) spoofing success of claim 1, wherein the private network device is a security device configured to protect one or more of the private network client devices.

6. The method of measuring Address Resolution Protocol (ARP) spoofing success of claim 5, wherein the method is repeated periodically to provide ongoing protection to the one or more private network client devices.

7. The method of measuring Address Resolution Protocol (ARP) spoofing success of claim 5, wherein the security device comprises one or more of a firewall, an anti-malware module, an Intrusion Detection System (IDS), and an Intrusion Protection System (IPS).

8. The method of measuring Address Resolution Protocol (ARP) spoofing success of claim 1, wherein the ping is an Internet Control Message Protocol (ICMP) ping.

9. The method of measuring Address Resolution Protocol (ARP) spoofing success of claim 1, further comprising notifying a user if ARP spoofing for one or more private network client devices is determined to be unsuccessful.

10. The method of measuring Address Resolution Protocol (ARP) spoofing success of claim 1, further comprising increasing a frequency of ARP packets sent as part of using Address Resolution Protocol (ARP) spoofing in response to determining that ARP spoofing for one or more private network client devices is unsuccessful.

11. A network security device, comprising:
a processor and a memory;
a malware protection module operable when executed on the processor to detect a threat to one or more private network devices and take one or more actions in response to detecting the threat; and
an Address Resolution Protocol (ARP) spoofing module operable to insert the network security device between a router or gateway and the one or more private network clients by using ARP spoofing, including sending a ping from the private network device to one or more of the private network clients using the IP address of the router or gateway and identifying the one or more private network clients as successfully ARP spoofed if a ping response is received.

12. The network security device of claim 11, wherein the ARP spoofing module is further operable to determine whether one or more private network clients is missing from the private network or was unsuccessfully ARP spoofed by pinging the private network clients from the private network device using the private network device's own IP address.

13. The network security device of claim 12, wherein if a response to a ping from the private network device using the private network device's own source IP address to a private network client device is received it is determined that the ARP spoofing was unsuccessful, and if response to the ping is received it is determined that the client device is not present in the private network.

14. The network security device of claim 11, wherein the ARP spoofing module operates periodically to provide ongoing protection to the one or more private network client devices.

15. The network security device of claim 11, wherein the network security device comprises one or more of a firewall, an anti-malware module, an Intrusion Detection System (IDS), and an Intrusion Protection System (IPS).

16. The network security device of claim 11, wherein the ping is an Internet Control Message Protocol (ICMP) ping.

17. The network security device of claim 11, wherein the ARP spoofing module is further operable to notify a user if ARP spoofing for one or more private network client devices is determined to be unsuccessful.

18. The network security device of claim 11, wherein the ARP spoofing module is further operable to increase a frequency of ARP packets sent as part of using Address Resolution Protocol (ARP) spoofing in response to determining that ARP spoofing for one or more private network client devices is unsuccessful.

19. A method of measuring Address Resolution Protocol (ARP) spoofing success for a private network device, comprising:
inserting the private network device between a router or gateway and one or more private network clients by using Address Resolution Protocol (ARP) spoofing;
sending a ping from the private network device to one or more of the private network clients using the IP address of the router or gateway;
identifying the one or more private network clients as successfully ARP spoofed if a ping response is received; and
determining whether one or more private network clients is missing from the private network or was unsuccessfully ARP spoofed by pinging the private network clients from the private network device using the private network device's own IP address, such that if a response to a ping from the private network device using the private network device's own source IP address to a private network client device is received it is determined that the ARP spoofing was unsuccessful, and if response to the ping is received it is determined that the client device is not present in the private network.
